(19) United States
(12) Patent Application Publication
(10) Pub. No.: US 2022/0306014 A1
(43) Pub. Date: Sep. 29, 2022

(54) Sensor Device for a Towing Vehicle in a Vehicle/Trailer Combination and Vehicle/Trailer Combination Having a Sensor Device of this Kind

(71) Applicant: Daimler Truck AG, Leinfelden-Echterdingen (DE)

(72) Inventor: Mohsen SEFATI, Sindelfingen (DE)

(21) Appl. No.: 17/637,339

(22) PCT Filed: Jul. 22, 2020
(86) PCT No.: PCT/EP2020/070625

§ 371 Date: Feb. 22, 2022

(30) Foreign Application Priority Data
Aug. 22, 2019 (DE) 10 2019 005 932.8

(51) Int. Cl. B60R 11/04

(52) U.S. Cl. CPC B60R 11/04; B60R 2011/008

(57) ABSTRACT

A sensor device for a towing vehicle in a vehicle/trailer combination includes a mount on which first and second sensors are disposed where the first and second sensors are arrangeable on a first side and a second side of the towing vehicle, respectively. The first sensor and the second sensor are each adjustable between a respective retracted position when the vehicle/trailer combination is driving in a straight line and a respective extended position when the vehicle/trailer combination is driving around a bend, where the first sensor and the second sensor are each adjustable along an arc between the retracted position and the extended position. An origin of radius of the arc lies on a vertical connection axis on the towing vehicle which runs parallel to a vertical vehicle axis and through a connecting element of the towing vehicle when the sensor device is attached to the towing vehicle.

### BACKGROUND AND SUMMARY OF THE INVENTION

The invention relates to a sensor device for a vehicle/trailer combination. The invention also relates to a vehicle/trailer combination having a sensor device of this kind.

Lorries which can be operated or driven at least partially autonomously are one of the most promising (commercial) applications in current efforts to achieve ever greater vehicle automation. Logistics and the transportation of goods offer a particularly strong market for such self-driving lorries, the market profiting considerably from the faster and more reliable transportation. Self-driving lorries typically comprise two main parts, that is to say a towing vehicle and a trailer. The trailer can be towed here by means of the towing vehicle such that—if it is correspondingly connected to the towing vehicle—the trailer can be moved with it. The trailer can also be steered by means of the towing vehicle, in other words the towing vehicle specifies a trajectory of travel which the trailer follows. Towing vehicles are usually very expensive and are therefore maintained by logistics and/or fleet management companies. Whilst towing vehicles (other than in special applications) are mainly used in storage facilities and on the public roads, trailers can be found anywhere where trailers are loaded and/or unloaded. It is also conceivable for the trailers to be loaded and unloaded themselves, for example onto trains and/or ships. Accordingly, the trailers are designed to be particularly robust since they are subject to very high loads, for example risking being damaged while being loaded onto and unloaded off trains and/or ships or during corresponding transportation by rail and/or sea. The trailers therefore need to be designed particularly simply and/or inexpensively and, in particular, to be kept free of sensitive electronic components.

There is a conflicting need, however, to monitor the surroundings of the lorry or the self-driving lorry particularly reliably in order to prevent or avoid accidents effectively, especially on the public roads. In relation hereto, FIG. 1 schematically shows a typical scenario in which the lorry 100, which has, for example, a towing vehicle 101 and a trailer 102, is changing lanes in urban surroundings where there is heavy traffic. The trailer 102 correspondingly follows the towing vehicle 101, thereby creating a blind spot 103 invisible to the driver which can be monitored neither by means of a conventional mirror device nor by means of a conventional sensor 104. This is because the conventional sensor 104 is firmly and rigidly attached to a longitudinal side 105 of the lorry 100, in particular of the towing vehicle 101, meaning that a sensor range 106 ascribed to the conventional sensor 104 is limited by the longitudinal side 105 itself. If other road users, in particular vulnerable road users, like pedestrians 107, cyclists, etc., or other motor vehicles or cars 108 are in the blind spot 103, they can be detected neither by the driver of the lorry 100 nor by the conventional sensor 104, so there is a particularly high risk of a road accident, for example if the lorry 100 is moving or starts moving again.

Accordingly, there is currently a need to monitor such a blind spot in order to minimize the risk of a road accident between the lorry and other road users. For this purpose, for example, DE 10 2014 006 961 A1 proposes a vehicle, in particular a utility vehicle, with a camera monitoring system as a mirror replacement system, with at least one camera which is attached to one or both sides on the outside of the vehicle so as to be directed backwards when viewed in the longitudinal direction of the vehicle, in particular in the top corner area at the front of a driver's cab in a utility vehicle, by means of a camera holder, wherein the camera holder has a controllable adjustment device with which the camera which is directed backwards can be moved into different positions spaced way from the vehicle depending on the situation. However, this camera monitoring system takes up a lot of space because it is extended translationally in a straight line parallel to a cross section of the vehicle from the driver's cab of the utility vehicle in order to keep any blind spot on the outside of the bend very small. As a result, the conventional utility vehicle equipped with this camera monitoring system “grows” wider, in particular when driving on the public roads. This is disadvantageous since, in the case of utility vehicles, a maximum permissible construction width is in any case exploited in order to be able to transport loads very efficiently.

DE 10 2016 209 927 A1 discloses a device for monitoring the surroundings of a vehicle, in particular for a mirror replacement system, with a first bearing element which can be connected to the vehicle in a positionally fixed manner, a second bearing element, a first pivot mechanism which connects the first and second bearing elements, and a sensor unit which has an optical axis, wherein the second bearing element can be identified in at least one specific angular position with respect to the first bearing element via the first pivot mechanism. The second bearing element is connected to a third bearing element via a second pivot mechanism and the sensor unit is arranged in the third bearing element.

DE 10 2012 015 395 also discloses a camera arm for a mirror-replacement camera in a motor vehicle. This contains a first housing element and a second housing element. The first housing element accommodates an image-capturing unit of the mirror-replacement system camera and the second housing element is adapted to be connected to the bodywork of the motor vehicle in a positionally fixed manner. A pivot mechanism is provided between the first housing element and the second housing element so that the first housing element can be pivoted about a pivot axis relative to the second housing element.

DE 10 2010 013 338 A1 also discloses a camera arrangement for a vehicle, comprising at least one camera with a protective covering, wherein the camera can be pivoted about a pivot axis between an initial position and an operating position.

DE 10 2017 125 101 A1 discloses a holding device for a vehicle. It contains a first element which can be attached to the vehicle, a second element which is moveably connected to the first element via a bearing mechanism, an image detection unit which is attached to the second element and is adapted so as to cover a detection range around the vehicle, and a signalling unit which is adapted to determine the position of the first element relative to the second element. The signalling unit has a signalling device which is adapted to emit a signal, and a signal generator which is adapted to actuate the signalling device irrespective of any position of the first element relative to the second element such that it emits a signal.

The problem underling the present invention is to provide a particularly reliable and particularly safe sensor device for a towing vehicle in a vehicle/trailer combination and a correspondingly reliably and safely operable vehicle/trailer combination.

This problem is solved according to the invention by a sensor device and by a vehicle/trailer combination. Advantages and advantageous configurations of the sensor device according to the invention are to be regarded as advantages and advantageous configurations of the vehicle/trailer combination according to the invention and vice versa.

A sensor device for a towing vehicle in a vehicle/trailer combination is accordingly provided according to the invention. The sensor device has a mount, on which at least one sensor is arranged on each side of the vehicle for monitoring the surroundings of the vehicle/trailer combination, which sensor can be adjusted between a retracted position when the vehicle/trailer combination is driving in a straight line and an extended position when the vehicle/trailer combination is driving around a bend.

A vehicle/trailer combination is to be understood herein to refer to a multi-sectioned motor vehicle, wherein the motor vehicle may be configured, for example, as a lorry. Accordingly, the vehicle/trailer combination or the lorry may be an articulated motor vehicle in which the towing vehicle is configured as a tractor truck and its trailer is configured as a semi-trailer. The vehicle/trailer combination may also be a lorry train, wherein the towing vehicle which can be used as a solo lorry and the trailer configured as a steerable drawbar trailer or centre-axle trailer are then connected to one another.

It is also conceivable for at least the towing vehicle of the vehicle/trailer combination to be configured as a passenger vehicle, for example as an omnibus, it then being possible for the omnibus to be connected to the trailer to form an articulated train.

Furthermore, the expression “vehicle/trailer combination” also includes articulated buses, irrespective of whether a front member of the articulated bus or a rear member of the articulated bus has a drive axle of the articulated bus.

The mount may be arranged on a bodywork, in particular on a driver's cab, of the towing vehicle, in particular attached thereto. At least one sensor is attached to the mount on each side of the vehicle so that—if the mount is attached to the bodywork of the towing vehicle—the sensors are attached to the towing vehicle via the mount.

The respective sensor may function or be configured according to an optical, acoustic and/or magnetic principle. The respective sensor may correspondingly have an image or camera sensor element, a laser sensor element, a lidar sensor element, a radar sensor element, an ultrasound sensor element and/or a magnet sensor element or Hall sensor element, etc.

The respective sensor can be adjusted in relation to the mount or in relation to the towing vehicle bodywork between the retracted position and the extended position, wherein the retracted position and the extended position may be respective end positions. In particular, an infinite number of intermediate positions are provided between the retracted position and the extended position, in other words the respective sensor can be adjusted or moved smoothly between the retracted position and the extended position.

In order to provide a particularly reliable and particularly safe sensor device for the towing vehicle of the vehicle/trailer combination, provision is made according to the invention for the respective sensor to be able to be adjusted along an arc between the retracted position and the extended position. The arc lies here entirely in a plane which is parallel to a plane stretching transversely and longitudinally through the vehicle. A respective adjustment track may be characterized by a path which the respective sensor has taken or takes between the extended position and the retracted position; alternatively or in addition, the adjustment track of the respective sensor may be characterized by an angle, the first arm of this angle, starting from a central point of the orbital path, intersecting the arc in the retracted position and the second arm thereof intersecting the arc in the extended position or vice versa.

It is advantageous here that a particularly large surface area, in particular in a rear area of the towing vehicle, can be detected and consequently monitored by means of the sensors of the sensor device, wherein the respective sensor remains particularly close to the bodywork or the driver's cab and/or to a structure of the towing vehicle owing to the adjustment of the respective sensor along the arc or along the orbital path. This means that a width of the towing vehicle is and remains particularly small despite the sensor being adjusted into the extended position. In other words, a width of the towing vehicle when moving or adjusting the respective sensor out of the retracted position into the extended position is only slightly larger, thus guaranteeing particularly safe presence on the public roads. In particular, the respective sensor does not extend transversely with respect to the vehicle beyond a mirror device which is attached to the towing vehicle anyway.

The invention is based on the idea that the sensor device can be operated independently of a trailer in the vehicle/trailer combination. This in turn means that the trailer has no elements or components required to operate the sensor device, for example sensor elements, transmitter elements, etc. As a result, the trailer is configured particularly robustly and can be manufactured particularly simply and inexpensively so that, for example, trailers already existing anyway in a fleet of vehicles can be used or can continue to be used in conjunction with the sensor device. Moreover, these particularly simply manufactured or manufacturable trailers are particularly sparing in terms of materials and/or resources, which is particularly favourable economically and ecologically.

It has proven to be particularly advantageous if an origin of radius of the arc lies on a vertical connection axis which axis runs parallel to a vertical vehicle axis on the towing vehicle and through a connecting element of the towing vehicle. The connecting element may, for example, be a coupling pin slot or kingpin slot, an open-end coupling element, etc. The connecting element on the towing vehicle may likewise be connected to a connecting element of a trailer corresponding thereto—that is to say to a connecting element on the trailer. If the connecting element on the towing vehicle and the connecting element on the trailer are connected to one another, the towing vehicle and the trailer form the vehicle/trailer combination.

In particular, if the vehicle/trailer combination is configured as an articulated motor vehicle, this has the advantage that (even if the towing vehicle and the trailer are disconnected from one another before being connected to one another) an angle between the towing vehicle and the trailer can directly influence a position of the respective sensor along the arc at any given time. This is advantageous, for example, when connecting the trailer to the towing vehicle if, during connection, the towing vehicle and the trailer are at a corresponding angle to one another. It also means that the adjustment of the respective sensor along the arc can be controlled particularly simply and efficiently. It is particularly preferable if, between the retracted and the extended positions of the respective sensor, there is an angle of adjustment of the sensor in relation to the origin of radius, wherein the angle of adjustment of the sensor corresponds to the angle between the towing vehicle and the trailer.

In a further configuration, the sensor device has an angle sensor device by means of which a curve angle of the towing vehicle and/or of the vehicle/trailer combination characterizing the driving around a bend can be detected and provided so that the at least one sensor can be adjusted between the retracted position and the extended position by reference to the curve angle. A curve angle or a sensor value characterizing the curve angle is to be understood to refer, for example, to a steering angle, steering wheel angle, the difference in the wheel speed between the wheels on the outside of the bend and the wheels on the inside of the bend, etc. Accordingly, the angle sensor device may, for example, have a steering angle sensor, a wheel speed sensor, etc., preferably sensor devices that are in any case provided in the towing vehicle whose sensor values are evaluated accordingly. Such sensor devices may, for example, be part of an anti-locking system, electronic stability control, etc. In this way, the respective sensor, starting from the towing vehicle driving in a straight line, during which the respective sensor is arranged in the retracted position, can be adjusted into the correspondingly extended position depending on whether the towing vehicle is driving around a bend. In particular, there is no longer any need for separate operation of the sensor device or of the respective sensors, for example by a driver of the towing vehicle.

In this context, it is particularly advantageous for the angle sensor device to have at least one sensor of the sensor system in order to detect the curve angle by means of the at least one sensor, in particular to detect it optically. This can be achieved, for example, by using the respective sensors of the sensor device to sense a subsurface while the towing vehicle is driving on it. It is also possible, if a trailer is connected or coupled to the towing vehicle, to use the angle sensor device to detect a kink angle—that is to say the angle between the towing vehicle and the trailer. This can be carried out, for example, through the already mentioned image or camera sensor element, if applicable in collaboration with corresponding image evaluation. This means that no active (sensor) elements are required on the trailer in the vehicle/trailer combination, thus especially addressing the need for a particularly simply and inexpensively configured trailer. The respective sensor in the sensor device also advantageously has dual functionality which is as conducive to efficient operation of the sensor device as a particularly simple configuration of the sensor device, in particular by saving on components.

The at least one sensor advantageously has a sensor range covering at least 270 degrees, preferably 360 degrees, about a vertical axis of the sensor. Consequently, the respective sensor may be a 360-degree laser scanner, a 360-degree lidar sensor, a 360-degree radar sensor, etc. Such sensors are known from the prior art and are accordingly highly developed and easily applicable. As a result, the sensor device can be manufactured with little additional expense.

The invention also relates to a vehicle/trailer combination with a towing vehicle which comprises a sensor device, in particular the sensor device described above. The vehicle/trailer combination also has at least one trailer connected to the towing vehicle. In order to configure the vehicle/trailer combination equipped with the sensor device to be particularly reliable and safe in its operation, provision is made according to the invention to arrange the at least one sensor aligned with a longitudinal side of the trailer on the towing vehicle.

Configured between the towing vehicle and the trailer is a gap which may be open or may be closed by means of a covering element (for example bellows, a tarpaulin, etc.). In particular, when driving in a straight line, that is to say with the respective sensor in the retracted position, the respective sensor may be arranged between the towing vehicle and the trailer along a longitudinal axis of the vehicle/trailer combination. In other words, the respective sensor may, in the retracted position, be arranged at the level of the gap or between the towing vehicle and the trailer.

Since the respective sensor can be adjusted from the retracted position into the extended position when driving around a bend, a rear of the trailer, in particular a longitudinal side, corner or edge of the trailer on the outside of the bend, can always still be monitored by means of the sensor device or the respective sensor since the corresponding sensor range of the sensor can be adjusted or is adjusted to the corresponding driving of the vehicle/trailer combination around a bend. This takes place by the at least one sensor, in particular a sensor on the outside of the bend, being moved out of the retracted position into the extended position when driving around a bend. This means that the blind spot 103 described at the beginning (see FIG. 1) is covered by the sensor range of the sensor arranged in the extended position, thus effectively preventing any risk of a road accident between the vehicle/trailer combination and any road users in the blind spot 103. Provision may be made, for example, for a driver of the vehicle/trailer combination or of the towing vehicle to be provided with a corresponding signal if other road users are in the blind spot 103 when driving around a bend. If the towing vehicle can be operated and/or driven at least partially autonomously or automatically, it is conceivable for the sensor device to be wirelessly or non-wirelessly connected to a braking system and/or a steering assembly of the towing vehicle so that, by reference to a corresponding sensor result from the sensor device, the towing vehicle can be steered and/or braked in order to avoid a threatened road accident.

When the vehicle/trailer combination is driving around a bend, the sensor of the sensor device on the outside of the bend can be adjusted towards the extended position owing to the trailer being at an angle in relation to the towing vehicle, such that a sensor range of the sensor on the outside of the bend runs along a longitudinal side of the trailer on the outside of the bend. This means that the vehicle/trailer combination may have a connecting device which, in turn, has the connecting element on the towing vehicle and connecting element on the trailer. In the case of the vehicle/trailer combination consisting of a towing vehicle and a trailer, the two connecting elements are connected to one another, for example by the connecting element on the trailer and the connecting element on the towing vehicle engaging into one another and, if applicable, being locked and/or otherwise attached to one another. The connecting device may, for example, be configured as a fifth-wheel coupling so that the vehicle/trailer combination is an articulated motor vehicle. Accordingly, when the vehicle/trailer combination or the articulated motor vehicle is driving around a bend, a front side of the trailer swings out towards the outside of the bend, as a result of which the sensor of the sensor device which is on the outside of the bend is carried along directly or indirectly with the front side or an edge of the front side of the trailer on the outside of the bend. As a result, a limit of the sensor range of the sensor on the outside of the bend runs along the longitudinal side of the trailer on the outside of the bend so that the rear of the trailer (as already described above), in particular while the vehicle/trailer combination is being driven, can automatically be monitored by means of the sensor device.

If the sensor device with which the vehicle/trailer combination is equipped has the angle sensor device, the curve angle characterizing the driving around a bend may have a kink angle between the towing machine and the trailer so that the at least one sensor can be adjusted between the retracted position and the extended position by means of the sensor device at least by reference to the kink angle. Therefore, if the vehicle/trailer combination is configured as an articulated motor vehicle, its connecting element or the coupling pin slot may have an angle sensor which can detect any rotation of the coupling pin about a coupling pin vertical axis. This means that the kink angle can be detected by means of the angle sensor device, by reference to which the respective sensor can be adjusted between the retracted position and the extended position. This offers the advantage of particularly reliable functioning of the vehicle/trailer combination or of the sensor device since a corresponding sensor position required along the arc depends on an actual angular position of the trailer in relation to the towing vehicle.

If the vehicle/trailer combination has the sensor device, wherein an origin of radius of the arc lies on the vertical connection axis running parallel to the vertical vehicle axis on the towing vehicle, it is ultimately also advantageous if the trailer has a further vertical connection axis, specifically on the trailer, which coincides with the vertical connection axis on the towing vehicle if the vehicle/trailer combination is arranged on a flat plane. This is because the trailer and the towing vehicle or the sections of the multi-sectioned motor vehicle are at an angle to one another when driving around a bend about a joint vertical axis of rotation. Accordingly, the adjustment track of the corresponding sensor along the arc (it being possible for this adjustment track to be characterized by the angle of adjustment of the respective sensor between the retracted position and the extended position) corresponds to the angle between the towing vehicle and the trailer—that is to say the kink angle. Consequently, particularly simple and/or efficient control of the sensor device of the vehicle/trailer combination is guaranteed.

Further advantages, features and details of the invention are set out in the following description of a preferable exemplary embodiment and by reference to the drawings. The features and feature combinations specified in the description above and the features and feature combinations specified in the description of the figures and/or shown in the figures alone below can be used not only in the combination specified in each case, but also in other combinations or on their own without falling outside the scope of the invention.

### BRIEF DESCRIPTION OF THE DRAWINGS

FIG. 1 shows a schematic view of a top of a conventional vehicle/trailer combination in a typical scenario of a change of lanes in urban surroundings where there is a high or dense volume of traffic;

FIG. 2 shows a schematic view of a top of a towing vehicle in a vehicle/trailer combination with a sensor device;

FIG. 3 shows a schematic view of the top of the towing vehicle of a towing vehicle equipped with the sensor device;

FIG. 4 shows a schematic view of the top of the vehicle/trailer combination while the vehicle/trailer combination is driving around a bend;

FIG. 5 shows a schematic view of the top of the vehicle/trailer combination while the vehicle/trailer combination is driving around a bend, with sensor ranges of sensors of the sensor device being highlighted; and

FIG. 6 shows a schematic view of the top of the vehicle/trailer combination in the typical scenario of the change of lanes in urban surroundings where there is a high or dense volume of traffic.

### DETAILED DESCRIPTION OF THE DRAWINGS

In the Figures, identical or functionally identical elements are given the same reference numerals.

Hereinbelow, with reference to FIG. 2 to FIG. 6, a sensor device 1 and a vehicle/trailer combination 2 are described together, that is to say in the same description.

FIG. 2 shows a schematic plan view of a towing vehicle 3 in the vehicle/trailer combination 2. To monitor the surroundings of the vehicle/trailer combination 2 or the towing vehicle 3, in particular while it is being driven, the sensor device 1 is attached to the towing vehicle 3. For this purpose, the sensor device 1 has a mount 4 on which at least one sensor 7 is arranged on each side of the vehicle 5, 6. The mount 4 is attached to a bodywork or to a structure of the towing vehicle 3 or integrated into the bodywork or into the structure. It is also conceivable for the mount 4 and the bodywork or the structure to be configured integrally with one another. Consequently, the sensors 7 are attached to the towing vehicle 3 via the mount 4. In the present example, the sensor device 1 has, in relation to a longitudinal plane, that is to say the x-z plane (see the coordinate systems in the Figs.), an adjustable sensor 8 on the left of the longitudinal plane and a further adjustable sensor 9 differing from the adjustable sensor 8 on the right of the plane. Provision is further made for the sensor device 1 to be configured symmetrically in relation to the x-z plane. This means that, hereinbelow, statements made in relation to the adjustable sensor 8 similarly apply to the adjustable sensor 9 and vice versa.

The mount 4 has at least two bearing elements 10 to which are attached in each case one of the two adjustable sensors 8, 9. The bearing element 10 can be adjusted in relation to a main body 11 of the mount 4, the adjustable sensor 8, 9 arranged thereon being moved along with the respective bearing element 10 when the respective bearing element 10 is adjusted. As a result, for example, the respective bearing element 10 may be surrounded at least in certain areas by the main body 11 of the mount 4, it then being possible to extend the respective bearing element 10 from the main body 11 and accordingly retract it again. FIG. 2 shows a status of the sensor device 1 in which both of the adjustable sensors 8, 9 are arranged in an fully retracted position. This fully retracted position is intended, for example, if the towing vehicle 3 and/or the vehicle/trailer combination 2 is driving in a straight line.

Conversely, FIG. 3 shows a schematic plan view of the towing vehicle 3 which driving around a bend. This means that the towing vehicle 3 is driving around a bend, in the present example a right-hand bend. Accordingly, the adjustable sensor 8 on the left-hand side can be adjusted out of the fully retracted position shown in FIG. 2 into an extended position. The adjustable sensors 8, 9 can be adjusted from the retracted position into the extended position owing to the respective driving around a bend. Provision is made for the adjustable sensors 8, 9 on the outside of the bend in each case to be able to be adjusted from the retracted position into the extended position as soon as the towing vehicle 3 drives around a bend. This means that, should the towing vehicle 3 drive around a left-hand bend, the sensor on the outside of the bend is then the adjustable sensor 9 which accordingly can be adjusted or is adjusted from the retracted position into the extended position.

There are an infinite number of intermediate positions between the fully retracted position and a fully extended position into which the adjustable sensors 8, 9 can be adjusted. This means that—starting from the fully retracted position—when the towing vehicle 3 is driving around a bend, the respective adjustable sensor 8, 9 can be adjusted towards the fully extended position into one of the intermediate positions, in particular depending on a radius of curvature of the bend around which the towing vehicle 3 is driving. If, for example, a radius of curvature of the driving of the towing vehicle 3 around the bend is large, provision is made for the adjustable sensor 8, 9 to be adjusted towards the fully extended position, but not entirely into the fully extended position. If the radius of curvature gets smaller, in particular while the towing vehicle 3 is driving around a bend, provision is then made for the adjustable sensor 8, 9 to be able to be adjusted or to be adjusted further towards the fully extended position. On the other hand, if the radius of curvature gets larger while the towing vehicle 3 is driving around a bend, provision is made for the adjustable sensor 8, 9 to be able to be adjusted or to be adjusted further towards the retracted position. As soon as the radius of curvature is 0—that is to say the towing vehicle 3 is driving in a straight line—the adjustable sensor 8, 9 is arranged fully entirely in the fully retracted position, as shown in FIG. 2.

It is particularly advantageous if the respective adjustable sensor 8, 9 can be adjusted along an arc 12 between the retracted position and the extended position. This gives a particularly large monitoring field around the towing vehicle 3 or the vehicle/trailer combination 2, the adjustable sensor 8, 9 remaining particularly close to the side of the vehicle 5, 6 during the adjustment and/or in the extended position or in the intermediate position.

In the present example, an origin of radius 13 of the arc 12 lies on a vertical connection axis 14 running parallel to a vertical vehicle axis (z-axis) on the towing vehicle and through a connecting element 15 of the towing vehicle 3. A radius 16 and the associated arc 12 lie in the same plane which is parallel to a plane stretching transversely y and longitudinally x through the vehicle.

The connecting element 15 may, for example, be a coupling pin slot if the towing vehicle 3—as in the present example—is configured as a tractor truck.

FIG. 2 and FIG. 3 also show that the sensor device 1 has an angle sensor device 17 which may be connected or is connected, on the one hand, wirelessly and/or non-wirelessly to the connecting element 15 of the towing vehicle 3 and, on the other, wirelessly and/or non-wirelessly to the sensor device 1. The angle sensor device 17 is configured to detect and provide a curve angle of the towing vehicle 3 and/or of the vehicle/trailer combination 2 characterizing the driving around a bend, in particular of the sensor device 1. As a result, the respective adjustable sensor 8, 9 can be adjusted between the retracted position and the extended position at least by reference to the curve angle. The curve angle of the towing vehicle 3 characterizing the driving around a bend may, for example, be a steering angle, a steering wheel angle, etc. of the towing vehicle 3. Similarly, the curve angle may be calculated or determined from a difference between corresponding wheel speeds of the wheels of the towing vehicle 3 on the outside and inside of the bend. Accordingly, the curve angle may be presented as a sensor value characterizing the curve angle which is sensed or detected by corresponding sensor devices of the towing vehicle 3, for example wheel speed sensors. For this purpose, it is advantageous to use sensor devices of an anti-locking system (ABS) of electronic stability control (ESP) etc. which are present in typical towing vehicles anyway. Consequently, provision may be made for the angle sensor device 17 to be connected or to be capable of being connected wirelessly and/or non-wirelessly to the corresponding sensor devices of the towing vehicle in order to guarantee an exchange of data between the sensor devices and the angle sensor device 17.

Alternatively or in addition, provision may be made for the angle sensor device 17 to use sensor values at least of one sensor 7 of the sensor device 1 in order to detect the curve angle characterizing the driving around a bend. For this purpose, the angle sensor device 17 may be connected wirelessly and/or non-wirelessly to at least one of the adjustable sensors 8, 9 so that, by means of the at least one adjustable sensor 8, 9 of the angle sensor device 17, a curve angle characterizing the driving around a bend or a corresponding sensor value is or can be provided.

In order to carry out particularly efficient and reliable monitoring of the surroundings of the towing vehicle 3, it is particularly advantageous if the at least one sensor 7 of the sensor device 1 has a respective sensor range which covers at least 270 degrees, preferably 360 degrees, about a vertical axis of the respective sensor 7. This means that the respective sensor 7 may be configured, for example, as a 360-degree laser scanner, a 360-degree lidar scanner, a 360-degree radar sensor, etc. Provision may also be made for the respective sensor 7 to be configured as an optical sensor, that is to say as an image or camera sensor. This means that the curve angle can be optically detected by means of the angle sensor device 17 by means of the at least one sensor 7 of the sensor device 1. For this purpose, for example, a subsurface on which the towing vehicle 3 is driving can be detected, for example sensed, by means of the at least one sensor 7, this giving the curve angle which can then be provided to the sensor device 1 in order to adjust the adjustable sensors 8, 9 between the retracted position and the extended position according to the driving around a bend.

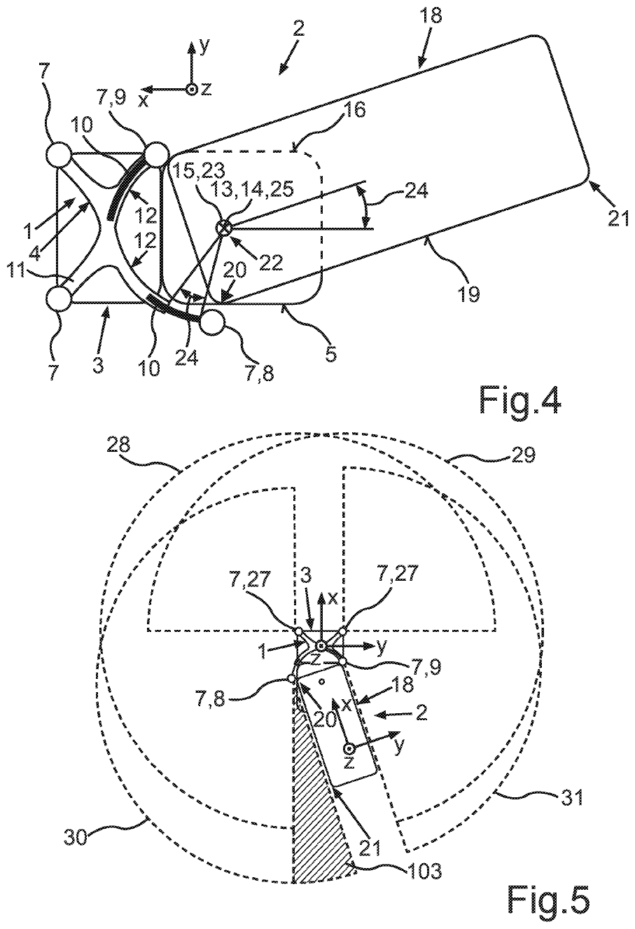

FIG. 4 shows a schematic plan view of the vehicle/trailer combination 2 while the vehicle/trailer combination 2 is driving around a bend. The present example shows the vehicle/trailer combination 2 driving around a right-hand bend; the statements—as already mentioned—similarly apply to the vehicle/trailer combination 2 driving around a left-hand bend. The vehicle/trailer combination 2 has the towing vehicle 3 and at least one trailer 18 connected to the towing vehicle 3 which, in the present example, is configured as a semi-trailer. As can be seen in FIG. 4, the adjustable sensor 8, 9 is arranged aligned with a longitudinal side 19 of the trailer 18 on the towing vehicle 3. This applies both to the vehicle/trailer combination 2 driving in a straight line and to the vehicle/trailer combination 2 driving around a bend. This is because, as the adjustable sensors 8, 9 can be adjusted when the vehicle/trailer combination 2 is driving around a bend, the adjustable sensor 8, 9, in particular the adjustable sensor 8, 9 on the outside of the bend, is carried along with a vertical edge 20 of the trailer 18 facing the towing vehicle and on the outside of the bend. As a result, a sensor range of the corresponding adjustable sensor 8, 9 is free or unblocked towards the rear of the vehicle/trailer combination or the rear of the trailer 18 when the vehicle/trailer combination 2 is driving around a bend so that a rear vertical edge 21 of the trailer 18 on the outside of the bend is arranged within a sensor range of the adjustable sensors 8, 9 on the outside of the bend. In other words, the surroundings of the vehicle/trailer combination 2 can be monitored particularly efficiently and safely even when driving around a bend, thereby effectively avoiding any blind spot (as described at the beginning).

Accordingly, when the vehicle/trailer combination 2 is driving around a bend, the adjustable sensors 8, 9 of the sensor device 1 on the outside of the bend can be adjusted towards the extended position owing to the trailer 18 being at an angle in relation to the towing vehicle 3. The sensor range of the sensor 8, 9 on the outside of the bend then runs along the longitudinal side 19 of the trailer 18 on the outside of the bend.

In the present example, the vehicle/trailer combination 2 is configured as an articulated motor vehicle which has a connecting device 22 which in turn has the connecting element 15 on the towing vehicle and a connecting element 23 on the trailer. In the case of the articulated motor vehicle or in the case of the vehicle/trailer combination 2, the connecting elements 15, 23 are connected to one another, for example by the connecting element 23 on the trailer and the connecting element 15 on the towing vehicle engaging into one another and, if applicable, being locked and/or otherwise attached to one another. Accordingly, the connecting device 22 may, for example, be a fifth-wheel coupling, a coupling pin (not shown) arranged on the trailer 18 engaging into a corresponding coupling pin slot arranged on the towing vehicle 3.

It is particularly advantageous if the corresponding adjustable sensor 8, 9 automatically follows the vertical edge 20 of the trailer 18 on the outside of the bend. In other words, there is no need for any separate operation and/or control of the adjustable sensor 8, 9 on the outside of the bend when the vehicle/trailer combination 2 or the articulated motor vehicle is being driven around a bend. If the vehicle/trailer combination 2 were being controlled, that is to say driven, by a user or operator, control of the adjustable sensor 8, 9 is therefore taken away from the driver or operator. If the vehicle/trailer combination 2 can be operated at least partially automatically or in at least partially automated fashion, that is to say, in particular, can be moved or driven driverlessly, provision may be made for the sensor device 1 to be able to be connected or to be connected wirelessly and/or non-wirelessly to corresponding control elements in order to control the vehicle/trailer combination 2 and/or the towing vehicle 3 partially automatically or in partially automated fashion. This means that adjusting the adjustable sensors 8, 9 between the retracted position and the extended position can be integrated into a drive control system of the driverlessly driveable towing vehicle 3.

FIG. 4 also shows a kink angle 24 between the towing vehicle 3 and the trailer 18 in relation to the connecting device 22 or in relation to the origin of radius 13 when the vehicle/trailer combination 2 is driving around a bend. Accordingly, the curve angle characterizing the driving around a bend may be the kink angle 24 so that the respective adjustable sensor 8, 9 can be adjusted between the retracted position and the extended position by means of the sensor device 1 at least by reference to the kink angle 24. This means that the kink angle 24 can be detected by means of the angle sensor device 17. For this purpose, the angle sensor device 17 may, for example, have an angle measuring instrument which is integrated, for example, into the connecting device 22 in order to detect or sense any twisting of the coupling pin within the coupling pin slot.

The kink angle 24 which is produced, on the one hand, between the towing vehicle 3 and the trailer 18 is, on the other, also produced between the retracted position of the respective adjustable sensor 8, 9 and the extended position of the same sensor 8, 9. In other words, the angle between the retracted position of the adjustable sensor 8, 9 and the extended position of the same adjustable sensor 8, 9 opens when the vehicle/trailer combination 2 kinks, that is to say with the trailer 18 twisting in relation to the vertical connection axis 14 and in relation to the towing vehicle 3. In other words again, the adjustable sensor 8, 9 on the outside of the bend is kinked in relation to the origin of radius 13 on the arc 12 by the kink angle 24.

Particular value is placed on the trailer 18 being free of components of the sensor device 1 so that the trailer 18, in this case the semi-trailer, can be or is constructed in a particularly simple and/or robust fashion. This means that the elements of the sensor device 1 are arranged entirely on the towing vehicle 3, resulting in a particularly advantageous operating concept since—apart from any possible supply of compressed air and any possible electricity supply—no supply lines have to be connected between the towing vehicle 3 and the trailer 18 if the towing vehicle 3 and the trailer 18 are being or are connected to one another. It is also advantageous that the towing vehicle 3 and the trailer 18 can be connected to one another forming the kink angle 24. This means that there is already the kink angle 24 between the trailer 18 and the towing vehicle 3 initially disconnected therefrom, that is to say during connection. The rear vertical edge 21 of the trailer 18 can then be monitored during connection by means of the adjustable sensors 8, 9. For this purpose, provision may be made for the adjustable sensors 8, 9 to be able to be adjusted from the retracted position into the extended position or towards the fully extended position even though the towing vehicle 3 is not driving around a bend.

With respect to the vehicle/trailer combination 2 or the articulated motor vehicle, the trailer 18 has a further vertical connection axis 25, specifically on the trailer, which coincides with the vertical connection axis 14 on the towing vehicle, at least if the vehicle/trailer combination 2 is arranged on a flat plane. This means that the arc 12 along which the adjustable sensors 8, 9 can be adjusted has the radius 16, the origin of radius 13 thereof being arranged both on the vertical connection axis 14 on the towing vehicle and on the vertical connection axis 25 on the trailer. In this case, the vertical edge 21 is also moved along a further arc differing from the arc 12 when the vehicle/trailer combination 2 kinks, the arc 12 and the further arc being concentric to one another. The radius 16 of the arc 12 is larger here than a radius of the further arc. By reference to the latter, it can be seen particularly easily that the kink angle 24 corresponds to the adjustment track of the respective sensor in terms of its angle.

FIG. 5 shows a schematic plan view of the vehicle/trailer combination 2 while the vehicle/trailer combination 2 is driving around a bend, a monitoring area 26 of the sensors 7 of the sensor device 1 being highlighted. It can be seen that a large proportion of the surroundings of the vehicle/trailer combination 2 can be monitored or is monitored by means of the sensor device 1. Since the sensors 7, as already mentioned, have at least 270 degrees, preferably 360 degrees, as a sensor range about a vertical axis of the sensor which runs parallel to the z-axis, this results, for sensors 27 of the sensor device 1 which are rigidly arranged in the present example, in a respective rigid sensor range 28, 29, the rigid sensor range 28 being assigned to the rigid sensors 27 on the left and the rigid sensor range 29 being assigned to the rigid sensors 27 on the right. FIG. 5 also shows that a variable sensor range 30 is assigned to the adjustable sensor 8 on the outside of the bend. Similarly, a further variable sensor range 31 is assigned to the adjustable sensor 9 on the inside of the bend. While the variable sensor range 31, that is to say the sensor range 31 on the inside of the bend, is partially blocked by the trailer 18 which kinks or has kinked in relation to the towing vehicle 3 when the vehicle/trailer combination 2 is driving around a bend, the variable sensor range 30 on the outside of the bend is accordingly extended by the adjustable sensor 8 on the outside of the bend being adjusted along the arc towards the extended position according to the kink angle between the towing vehicle 3 and the trailer 18. The blind spot 103, which is shown merely to aid understanding, is therefore covered by means of the variable sensor range 30 on the outside of the bend and consequently does not arise in the case of the sensor device 1 or in the case of the vehicle/trailer combination 2 equipped with the sensor device 1.

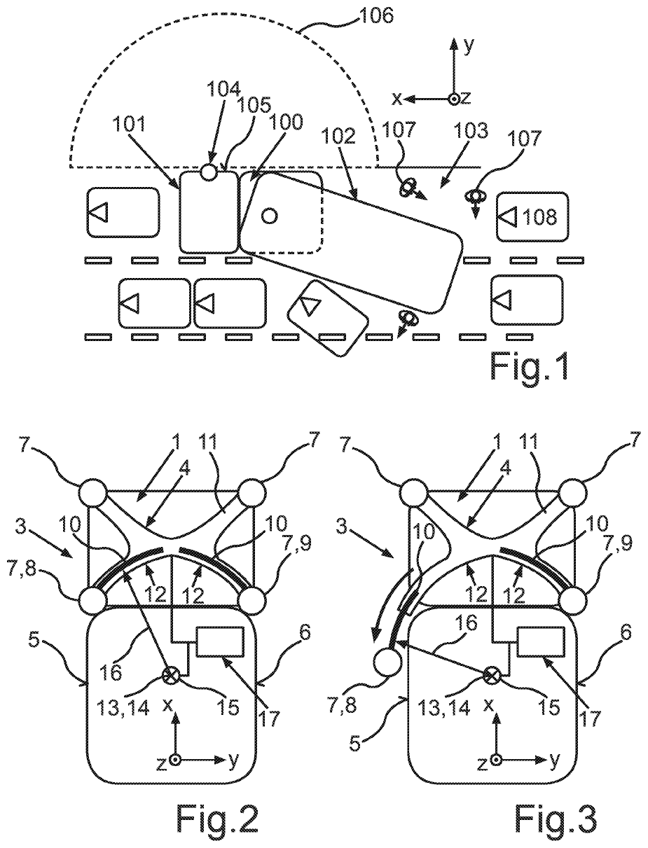

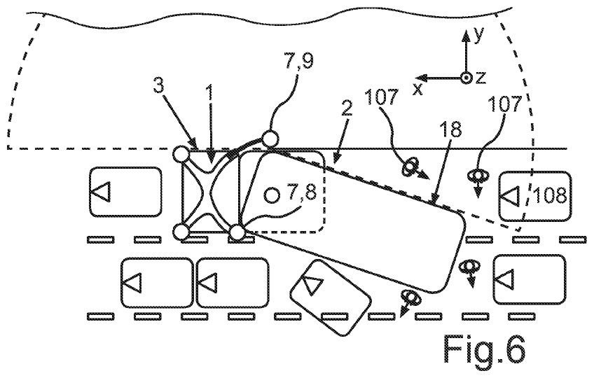

FIG. 6 shows a schematic view of the vehicle/trailer combination 2 which is changing lanes in a typical scenario in urban surroundings where these is a dense or high volume of traffic. It can be seen particularly clearly here—especially compared to the scenario shown in FIG. 1—how the surroundings or periphery of the vehicle/trailer combination 2 can be monitored particularly efficiently over a large area by means of the sensor 8, 9 on the outside of the bend in order to keep the risk of an accident particularly low. Pedestrians 107 who are in the blind spot 103 in the scenario in FIG. 1 can be detected by means of the sensor device 1 just like the car 108 which is in the blind spot 103 in FIG. 1.

Overall, the invention shows how the surroundings of the vehicle/trailer combination can better be monitored by means of the sensor device 1 or by means of the vehicle/trailer combination 2 equipped with the sensor device 1 without any elements of the sensor device 1 whatsoever being arranged on the trailer 18. The proposed sensor device 1 or the proposed vehicle/trailer combination 2 is an adaptive and active sensor positioning system which is arranged on the towing vehicle 3, particularly preferably on a roof of the towing vehicle 3, wherein the sensors 8, 9 which are directed backwards can be arranged or are arranged in a constantly optimal position in relation to a vehicle driving around a bend or in relation to a position of the trailer 18. The sensors 27 at the front may be arranged to be rigid, wherein the sensors 8, 9 which are directed backwards can be adjusted along an arc, in particular along the arc 12. Consequently, the adjustable sensors 8, 9 can always be brought into a respective position in which the longitudinal side 19 of the trailer 18 can always be monitored by means of the corresponding sensor 8, 9 since this longitudinal side 19 then always remains arranged in the sensor range of the corresponding sensor 8, 9.

In order always to determine reliably the position in which the adjustable sensor 8, 9 is arranged, provision may be made for the mount 4 to have further, integrated sensors which can be used to determine the position in which the respective sensor 8, 9 is arranged at any given time. This can be achieved, for example, by stepper motors being used to adjust the sensors 8, 9 in relation to the mount 4 or in relation to the respective sides of the vehicle 5, 6.

As the respective adjustable sensor 8, 9 can be moved along the arc 12, in particular on the outside of the towing vehicle 3, the respective adjustable sensor 8, 9 is moved along in a lateral direction, that is to say transversely or in the y-direction, particularly close to the outside of the towing vehicle 3. In particular, when the adjustable sensor 8, 9 is being adjusted, it does not move beyond a maximum permitted vehicle width, for example beyond a lateral extension of a mirror device of the towing vehicle 3. As a result, the vehicle/trailer combination 2 can also be moved or driven particularly advantageously in urban surroundings where there is a high or dense volume of traffic.

Furthermore, the sensor device 1 or the vehicle/trailer combination 2 accommodates very well the idea of particularly advantageous vehicle automation. This is because, although the trailer 18 is not equipped with technology for sensing its surroundings, particularly extensive monitored surroundings of the vehicle/trailer combination 2 are achieved by means of the sensor device 1 or by means of the vehicle/trailer combination 2, so an at least partially automatic or automatedly drivable towing vehicle 3 accordingly equipped with the sensor device 1 can be moved particularly safely, in particular on the public roads.

1.-8. (canceled)

9. A sensor device for a towing vehicle in a vehicle/trailer combination, comprising:
a mount on which a first sensor and a second sensor are disposed, wherein the first sensor and the second sensor are arrangeable on a first side and a second side of the towing vehicle, respectively, for monitoring surroundings of the vehicle/trailer combination;
wherein the first sensor and the second sensor are each adjustable between a respective retracted position when the vehicle/trailer combination is driving in a straight line and a respective extended position when the vehicle/trailer combination is driving around a bend, wherein the first sensor and the second sensor are each adjustable along an arc between the retracted position and the extended position;
wherein an origin of radius of the arc lies on a vertical connection axis on the towing vehicle which runs parallel to a vertical vehicle axis and through a connecting element of the towing vehicle when the sensor device is attached to the towing vehicle.

10. The sensor device according to claim 9, further comprising an angle sensor device via which a curve angle of the towing vehicle or of the vehicle/trailer combination which characterizes the driving around the bend is detectable and providable such that the first sensor and the second sensor are adjustable between the retracted position and the extended position by reference to the curve angle.

11. The sensor device according to claim 10, wherein the angle sensor device is connected to at least one of the first sensor and the second sensor in order to detect the curve angle via the at least one of the first sensor and the second sensor.

12. The sensor device according to claim 9, wherein the first sensor and the second sensor have a respective sensor range which covers at least 270 degrees about a respective vertical axis of the first sensor and the second sensor.

13. A vehicle/trailer combination, comprising:
a towing vehicle;
a trailer connected to the towing vehicle; and
a sensor device, wherein the sensor device includes:
a mount on which a first sensor and a second sensor are disposed, wherein the first sensor and the second sensor are arranged on a first side and a second side of the towing vehicle, respectively, for monitoring surroundings of the vehicle/trailer combination;
wherein the first sensor and the second sensor are each adjustable between a respective retracted position when the vehicle/trailer combination is driving in a straight line and a respective extended position when the vehicle/trailer combination is driving around a bend, wherein the first sensor and the second sensor are each adjustable along an arc between the retracted position and the extended position;
wherein an origin of radius of the arc lies on a vertical connection axis on the towing vehicle which runs parallel to a vertical vehicle axis and through a connecting element of the towing vehicle;
wherein the first sensor and the second sensor are disposed aligned with a respective longitudinal side of the trailer on the towing vehicle.

14. The vehicle/trailer combination according to claim 13, wherein when the vehicle/trailer combination is driving around the bend, a one of the first sensor and the second sensor that is on an outside of the bend is adjusted towards the respective extended position owing to the trailer being at an angle in relation to the towing vehicle such that a sensor range of the one of the first sensor and the second sensor that is on the outside of the bend runs along a longitudinal side of the trailer on the outside of the bend.

15. The vehicle/trailer combination according to claim 13, wherein:
the sensor device further includes an angle sensor device via which a curve angle of the towing vehicle or of the vehicle/trailer combination which characterizes the driving around the bend is detectable and providable such that the first sensor and the second sensor are adjustable between the retracted position and the extended position by reference to the curve angle; and
the curve angle has a kink angle between the towing vehicle and the trailer such that, via the sensor device, the first sensor and the second sensor are adjustable between the retracted position and the extended position at least by reference to the kink angle.

16. The vehicle/trailer combination according to claim 13, wherein the trailer has a vertical connection axis which coincides with the vertical connection axis on the towing vehicle when the vehicle/trailer combination is disposed on a flat plane.
